(19) United States
(12) Patent Application Publication
(10) Pub. No.: US 2009/0009820 A1
(43) Pub. Date: Jan. 8, 2009

(54) Image forming apparatus

(75) Inventor: Yasuhiro Fukui, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 12/213,572

(22) Filed: Jun. 20, 2008

(30) Foreign Application Priority Data
Jul. 3, 2007 (JP) 2007-174893

(51) Int. Cl. H04N 1/387; G03G 15/36; H04N 1/40

(52) U.S. Cl. 358/449; 358/453; 382/199; 358/451; 358/450

(57) ABSTRACT

The image forming apparatus comprises:an area extraction portion for detecting a boundary between a not-printed area and an effective image area which is not a not-printed part in image data in both the fast scan and slow scan directions and for extracting one or a plurality of the effective image areas; a sheet selection portion for in forming an image selecting the smallest possible sheet of the sheets which have a size to accommodate the image to be formed and are used by the apparatus; and an image forming portion for forming the image on the sheet selected which the sheet selection portion selects based on the image data in the effective image area extracted by the area extraction portion.

This application is based on Japanese Patent Application No. 2007-174893 filed on Jul. 3, 2007, the contents of which are hereby incorporated by reference.

### BACKGROUND OF THE INVENTION

1. Field of the Invention

The present invention relates to an image forming apparatus which extracts an image area from image data obtained by reading a document or from image data input from outside, and prints the image.

2. Description of Related Art

Conventionally, there is an image forming apparatus (e.g., a copy machine, a multi-function printer, a printer or the like) known for that it reads an image on a document, and prints it based on the image data read from the document, or image data input from outside. Such an image forming apparatus usually has various functions (e.g., enlargement/reduction function, frame erasing function or the like) for convenience of users. These functions are executed by applying some image processing to image data.

There is an image forming apparatus disclosed in, for example, JP-A-1995-283935. Specifically, disclosed in JP-A-1995-283935 is an image forming apparatus which has: a document tray on which a document is placed; scan means for scanning the document; specification means for specifying a desired area of the document; and print means for printing an image located on the specified area of the document and scanned by the scan means according to the specified area and the size of a printing material. Thus a try has been made to obtain an image easy to read by printing the image located on the specified area on the center of a printing material according to the specified area and the size of the printing material.

Here, there is a case where a user clips a necessary part only from a sheet on which an image is formed with a cutting machine, a cutter or a pair of scissors or the like, and uses the clipped part for another purpose (forming a material, filing or the like). In this clipping, if there is a large not-printed part compared with the necessary part, the large part of the sheet is thrown away. This is much waste and a problem from the view point of effective use of resources. When forming an image, the larger the not-printed part is, the more the electric power is used. Besides, if a sheet is too large compared with the necessary part, it requires all the longer time for forming the image, which is also a problem in terms of productivity. In addition, if the not-printed part is large, the data size of the image will be all the more, which is inefficient. The size of image data is preferably small from the view point of processing speed, memory size or the like.

Referring to the image forming apparatus disclosed in JP-A-1995-283935, a user can specify an area which the user desires, carries out centering of the area and print it, which indeed enhances the visibility of the image formed. However, JP-A-1995-283935 does not disclose wastes of resources and electric power caused by throwing away much part of a sheet when clipping a necessary part from the sheet, a problem with productivity, and a measure to reduce the size of image data. Moreover, there is a problem that after centering, because the image located in the specified area is formed on the center of the sheet, more than four edges must be cut away when clipping a necessary part, which requires a long time for the clipping.

### SUMMARY OF THE INVENTION

The present invention has been made to cope with the conventional problems, and it is an object of the present invention to provide an image forming apparatus which removes a not-printed part from image data, extracts an effective image area, and selects a sheet to be used according to the effective image area, and thus eliminates wastes of the sheet and electric power, enhances productivity, and reduces the size of the image data.

To achieve the above objects, according to a first aspect of the present invention, an image forming apparatus is provided with: an area extraction portion for detecting a boundary between a not-printed part and an effective image area, that is, an image part which is not a not-printed part in both directions of the fast scan direction and the slow scan direction and thus extracting one or a plurality of the effective image areas; a sheet selection portion for selecting the smallest possible sheet of the sheets which the apparatus is able to use and on which an image to be formed is able to be accommodated; and an image forming portion for forming an image on the sheet selected by the sheet selection portion based on the image data in the effective image area extracted by the area extraction portion.

According to this structure, because an effective image area is extracted by detecting a boundary between a not-printed area and an effective image area in both directions of the fast scan direction and the slow scan direction, the not-printed part in the image data can be removed. Because the smallest possible sheet that can accommodate the extracted effective image area is selected by the sheet selection portion, and because the image in the effective image area is formed on this selected sheet, for example, in full-size (100% magnification), the sheet size can be automatically reduced. Besides, because the image data can be processed in full-size, the visibility of the effective image area can be maintained. Sheet wastes produced at the time of clipping can be minimized. The time required for the image formation is shortened, the productivity is increased and the power consumption is reduced. The image data size can also be reduced.

Here, a not-printed area is an area in a sheet or image data where a writing, graphics, symbols, pictures, patterns or the like are not printed. In other words, a not-printed area is a blank area where its color is identical to that of the document sheet, and does not have any information to be transmitted. On the other hand, an effective image area is a block of area where a writing, graphics, symbols, pictures, patterns or the like are printed, and which is not recognized as a not-printed area. For example, one part in one sheet where the marginal parts arranged in the area extending from the surrounding edge parts to the inside are cut away can be used as an effective image area. Besides, for example, when the printed effective image areas are distant from each other and they can be extracted separately, a plurality of effective image areas may be extracted from one sheet.

It is preferable to have a position adjustment portion which positions at least one of the extracted effective image areas by moving it to the upper edge or to the lower edge, and the position adjustment portion preferably adjusts the positions of a plurality of the effective image areas extracted from image data on one or a plurality of sheets by arranging them on one sheet. Thus the effective image areas are positioned by moving them to the upper edge or to the lower edge, thereby the readability and visibility of the formed image can be enhanced. Besides, when clipping a necessary part, because the effective image area is already moved to either edge of a sheet, the clipping can be easily done. Because a plurality of effective image areas can be arranged and positioned on a sheet, it is possible to concentrate the plurality of effective image areas on the sheet without degrading the visibility and to curb the amount of sheets to be used. The sheet waste produced at the time of clipping an image, the power consumption, and the image data size can also be reduced.

The area extraction portion preferably detects a boundary between the effective image area and the not-printed area based on an edge (a part where the density sharply changes) in image data detected in both fast scan and sow directions. Because an edge of image data is detected in both fast scan and slow scan directions in the image data on a sheet, the boundary between the effective image area and the not-printed part can be detected exactly.

Moreover, it is preferable to have a document reading portion which reads a document and generates image data on the document, and the area extraction portion preferably extracts the effective image area from the image data which is read and generated by the document reading portion. Because the effective image area can be extracted from the image data which is read and obtained by the document reading portion, for example, editing of a user's material, magazine or the like can be done quickly.

It is preferable to have a detection portion of an image data size which detects a sheet size for image data based on which the image is formed. With the image data size detection portion, it is possible to refer to sheet sizes for image data, to print an image using a sheet smaller than the detected sheet size, and also possible to enhance the detection precision of a boundary between a not-printed part and an effective image area.

It is preferable to have a document size detection portion which detects the size of a document which is read. With the document size detection portion, it is possible to print an image using a sheet smaller than the detected sheet size, and to enhance the detection precision of a boundary between a not-printed part and an effective image area by referring to the size of the document read.

It is preferable to have an operation input portion which operates and commands the apparatus and, and the operation input portion preferably receives a level setting of a threshold for the detection of a boundary between a not-printed part and an effective image area. Because a user can conduct a level setting of a threshold, the user can control the extraction of an effective image area, and the user's convenience is enhanced. For example, if the extraction of a boundary between a not-printed part and an effective image area is unsatisfactory, a user can detect a boundary and extract an effective image area which the user desires by adjusting a threshold level.

It is also preferable to have a storage portion which stores an extracted effective image area as image data. Because the storage portion stores the image data of the extracted effective image area that is obtained by removing the data of the not-printed part, the image data having a small data size can be stored.

Besides, it is also preferable to have a zoom processing portion which enlarges or reduces an image data size, and the zoom processing portion preferably enlarges or reduces an effective image area. Even if one or a plurality of effective image areas cannot be accommodated on a sheet of paper in full-size, it can be accommodated within the sheet if it is reduced. In addition, even if one or a plurality of effective image areas are arranged on a sheet of paper with the not-printed part remained on it, if the effective image area is enlarged, the entire sheet can be used effectively, so that the image on the effective image area can be easily read.

### BRIEF DESCRIPTION OF THE DRAWINGS

FIG. 1 is a schematic sectional view of a multi-function printer according to a first embodiment.

FIG. 2A is a partially enlarged schematic sectional view of an image forming portion of the multi-function printer according to the first embodiment. FIG. 2B is a view to explain an operation panel in the first embodiment. And FIG. 2C is an enlarged view of a liquid crystal display showing an example of an area extraction situation displayed on the operation panel in the first embodiment.

FIG. 3 is a block diagram to explain a configuration example of the multi-function printer according to the first embodiment.

FIG. 4 is a view to explain cases where an effective image area is extracted from a sheet of image data in the first embodiment, wherein FIG. 4A shows a case where an image is formed on a sheet whose size is smaller than that of the sheet for the original image data, and FIG. 4B shows a case where an effective image area is relatively large.

FIG. 5 is a view to explain cases where a plurality of effective image areas are extracted from image data and are arranged on one sheet in the first embodiment, wherein FIG. 5A shows a case where effective image areas are extracted from on a plurality of sheets of image data, and FIG. 5B shows a case where a plurality of effective image areas are extracted from one sheet of image data.

FIG. 6 is a flowchart to explain processing applied to an effective image area in the first embodiment.

FIG. 7 is a view to explain cases where an effective image area is extracted from a sheet of image data in a second embodiment, wherein FIG. 7A shows a case where an image is formed on a sheet whose size is smaller than that of the sheet for the original image data, and FIG. 7B shows a case where an effective image area is large.

FIG. 8 is a view to explain a case where a plurality of effective image areas are extracted from a plurality of sheets of image data and arranged on one sheet in the second embodiment.

FIG. 9 is a flowchart to explain processing applied to an effective image area in the second embodiment.

### DETAILED DESCRIPTION OF PREFERRED EMBODIMENTS

### First Embodiment

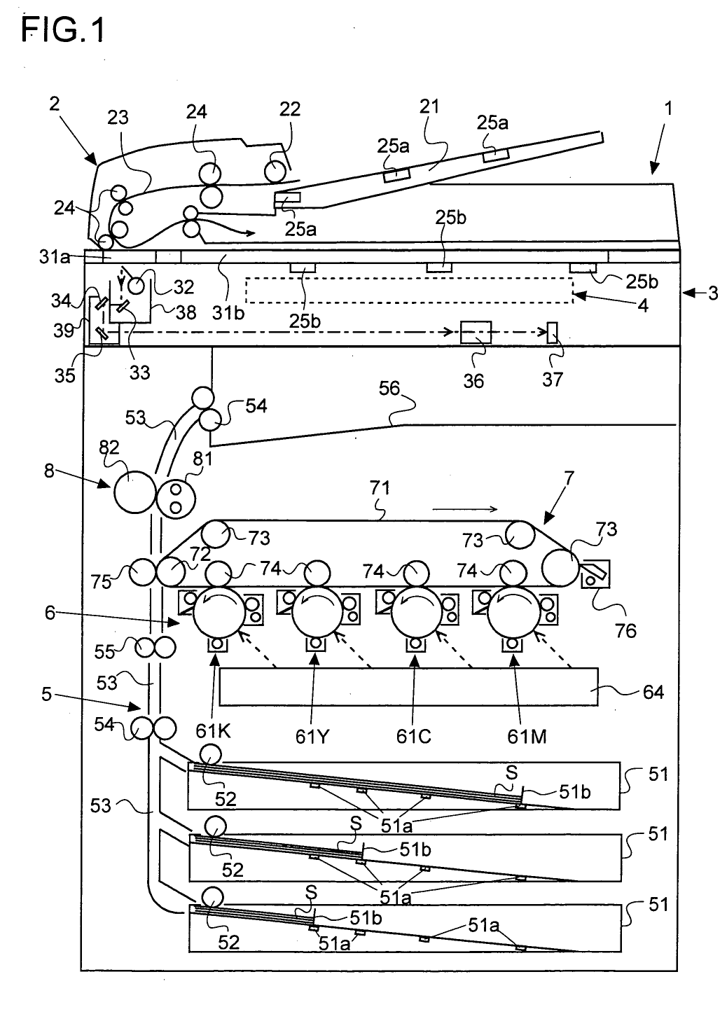

Hereinafter, a first embodiment of the present invention will be described based on FIGS. 1 to 6. In the present embodiment, explained is a case where image data extracted (an effective image area T2) is printed in full size.

To begin with, a multi-function printer 1 (corresponding to an image forming apparatus) of the digital electro-photographic type according to the first embodiment of the present invention is schematically explained.

The multi-function printer 1 according to the present embodiment, as shown in FIG. 1, has a document carrying apparatus 2 at the uppermost part, a document reading portion 3 under the document carrying apparatus 2, and in the main body of the multi-function printer 1, has a sheet supplying/carrying portion 5, an image forming portion 6, an intermediate transfer portion 7, and a fixing portion 8, and at the upper part (shown by a broken line) of the front of the multi-function printer 1, has an operation panel 4 (corresponding to an operation input portion).

First, the document carrying apparatus 2 sends documents placed on the document receiving tray 21 one after another to a document carrying passage 23 with a document roller 22, and further carries automatically and continuously the documents with a plurality of pairs of document carrying rollers 24 to a carrying contact glass plate 31a located on the upper part of the document reading portion 3. The document carrying apparatus 2 has its fulcrum about which the apparatus is liftable and can read documents such as books, newspapers or the like placed on the document receiving contact glass plate 31b one after another.

A plurality of optical sensors 25a (corresponding to a document size detection portion) which detect a document size are placed in the document receiving tray 21 in the direction perpendicular to this page (in the depth direction of the multi-function printer 1). The plurality of optical sensors 25a may be arranged in the document receiving tray 21 along the document carried direction. Besides, a plurality of optical sensors 25b (corresponding to the document size detection portion) may be arranged on the lower surface of the document receiving contact glass plate 31b in the depth direction of the multi-function printer 1, or may be arranged in the document carried direction. With these plurality of optical sensors 25a and 25b, the sizes of documents placed on the document receiving tray 21 or on the contact glass plate 31b are detected.

Then, the document reading portion 3 reads an image on the document, converts the image into electric signals to generate image data. To carry out the processing, the document reading portion 3 has the contact glass plate 31 on its upper part, and inside thereof, has an exposure lamp 32, mirrors 33, 34 and 35, a lens 36, and an image sensor 37.

The contact glass plate 31 is divided into two parts, that is, the carrying contact glass plate 31a is placed on the left side, and the document receiving contact glass plate 31b is placed on the right side. The exposure lamp 32 is disposed under the contact glass plate 31 extending in the direction perpendicular to this page. The mirrors 33, 34, and 35 guide light which is directed from the exposure lamp 32 to a document and reflected off to the lens 36.

The reflected light is condensed by the lens 36 and input into the image sensor 37 (e.g., a line sensor of CCD), where the light is converted into electric signals depending on the image density. Then, the electric signals are amplified by an amplifying apparatus (not shown) and quantized depending on color, density or the like. Consequently, the document image is read as digital image data.

The exposure lamp 32, mirrors 33, 34, and 35 are fixed in a movable box 38. The movable box 38 can be horizontally moved by a motor (not shown), a wire (not shown) and the like. As the movable box 38 is moved horizontally, a document placed on the document receiving contact glass plate 31a is read. To read a document passing the carrying contact glass plate 31a, the movable box 38 is disposed under the carrying contact glass plate 31a.

The sheet supplying/carrying portion 5 sends out and carries a sheet S, for example, copy paper, an OHP sheet, a label sheet or the like. The sheet supplying/carrying apparatus 5 is composed of a cassette 51, a pickup roller 52, a sheet carrying passage 53, a pair of carrying rollers 54 and the like. A plurality of cassettes 51 are disposed (three in FIG. 1), and can be added as an option. Cassettes 51 accommodate sheets of various sizes (e.g., 8½ in.×11 in., 5½ in.×8 in., A4, A3, B5 sizes etc.). Accordingly, the cassettes 51 are provided with a plurality of optical sensors 51a in the carrying direction and in the direction perpendicular to the carrying direction. A control portion 9 described later receives outputs from the optical sensors 51a and the sizes of the sheets S stored in the cassettes 51a are recognized. The size of the sheet S may be recognized in the following way: a variable resistor is connected to a limit plate 51b that limits the movement of the sheets S accommodated; the size of the sheet S is recognized by making use of the phenomenon that resistance of the variable resistor connected to the limit plate 51b changes depending on slide positions of the limit plate 51b.

The pickup roller 52 is rotated by a motor (not shown) in a given direction (clockwise in Fig.) when a print command is input on the multi-function printer 1, and feeds the sheets S into the sheet carrying passage 53 one after another. The sheet carrying passage 53 carries the sheet S to the delivery tray 56 via the intermediate transfer portion 7 and the fixing portion 8. The sheet carrying passage is provided with a plurality of carrying rollers 54, a plurality of guides, and a pair of resist rollers 55 which stops the sheet S carried before the intermediate transfer portion 7 for a temporary wait.

The image forming portion 6 forms a toner image based on the image data of an image to be formed. Specifically, the image forming portion 6 is composed of image forming units 61M (magenta), 61C (cyan), 61Y (yellow), and 61K (black) that are arranged to respectively form an image having each color of magenta, cyan, yellow, and black, and a laser unit 64. These toner images of the different colors are overlaid to form a full-color image.

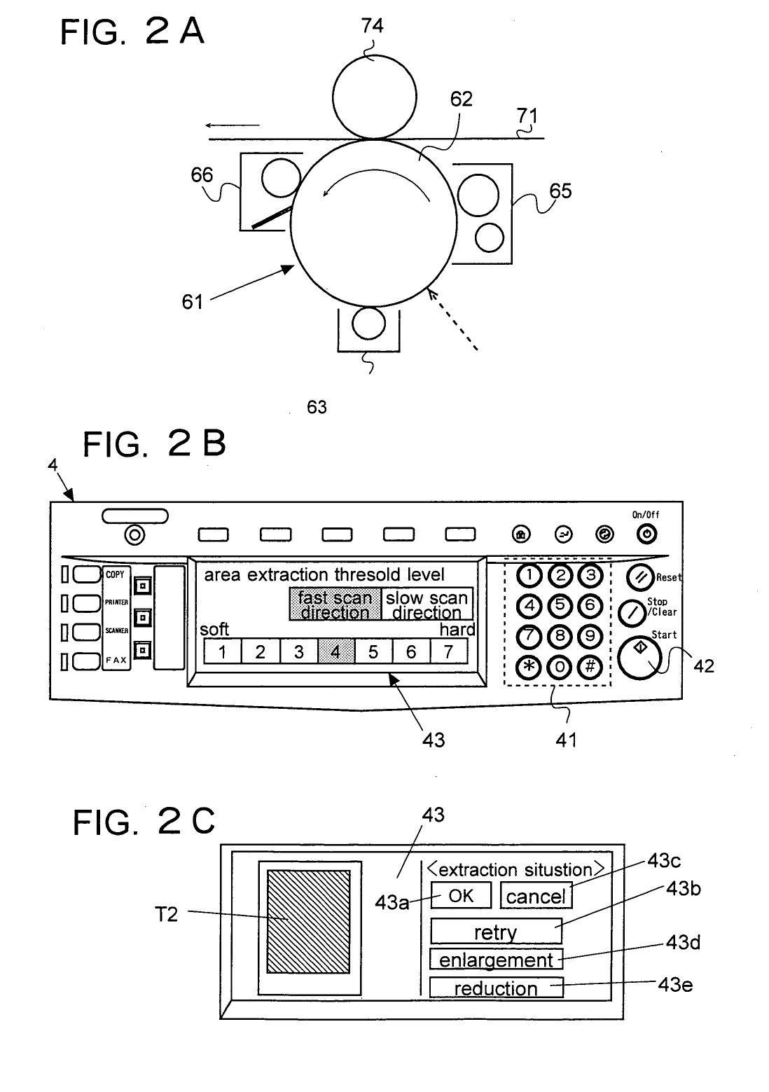

Here, the image forming units 61M, 61C, 61Y, and 61K are different from each other only in colors of toner images formed, and have the same structure in principle. Accordingly, hereinafter, the image forming unit 61 is collectively used, and the alphabets M, C, Y, and K are omitted unless they are necessary. As shown in FIGS. 1 and 2, each image forming unit 61 has a photosensitive drum 62, and about which a charging apparatus 63, a developing apparatus 65, and a cleaning member 66 are arranged. A laser unit 64 is disposed under the image forming units 61. The photosensitive drum 62 has a photosensitive layer (e.g., amorphous silicon) on the outer surface. The photosensitive drum 62 is arranged extending in the direction perpendicular to the pages of FIGS. 1 and 2A, and a toner image is formed on the circumferential surface. The photosensitive drum 62 is driven to rotate counterclockwise by a motor (not shown), a gear (not shown) in FIG. 1.

The charging apparatus 63 is disposed on the lower position of the photosensitive drum 62 to charge the circumferential surface of the photosensitive drum 62 at a given potential. The laser unit 64 directs light to each photosensitive drum 62 charged based on the image data of an image to be formed and forms an electrostatic latent image scanning the circumferential surface of the photosensitive drum 62. In the present embodiment, a known apparatus such as a printer head comprising a plurality of LEDs may be used an exposure apparatus instead of the laser unit 64.

The developing apparatus 65 charges the stored toner at a given potential, supplies some of the toner to an electrostatic latent image on the circumferential surface of the photosensitive drum 62 to develop the electrostatic latent image. The cleaning member 66 is, as shown in FIG. 2, disposed on the upper left position of the photosensitive drum 62, removes and collects adhering matters such as water content, dust, toner residues and the like.

As shown in FIG. 1, the intermediate transfer portion 7 is disposed over the image forming apparatus 6, and receives a first transfer of the toner images having their respective colors formed by the image forming apparatus 6 before transferring the toner images on the sheet S. The toner images having their respective colors are overlaid on an intermediate transfer belt 71 to form a full-color image. The intermediate transfer belt 71 is mounted on a driving roller 72, three driven rollers 73, and four first transfer rollers 74. The outer surface of the intermediate transfer belt 71 and each photosensitive drum 62 contact each other.

Driving means (not shown) comprising a motor, a gear and the like is connected to the driving roller 72, and the intermediate transfer belt 72 moves around clockwise (in the arrow direction). The four first transfer rollers 74 contact the intermediate transfer belt 71, face each photosensitive drum 62, and are disposed rotatably. To transfer a toner image from the photosensitive drum 62 to the intermediate transfer belt 71, a voltage (bias) in a given range is applied to the first transfer roller 74. A belt cleaning apparatus 76 removes remaining toner which is not transferred from the intermediate transfer belt 71 to the sheet S.

The intermediate transfer portion 7 is equipped with a second transfer roller 75. The second transfer roller 75 faces the driving roller 72, contacts the intermediate transfer belt 71 to be rotatably supported. A given voltage (bias) is applied to the second transfer roller 75 to conduct the second transfer of a full-color toner image onto the sheet S when the toner image and the sheet S go into the nip (the second transfer part) between the second transfer roller 75 and the intermediate transfer belt 71.

The fixing portion 8 is chiefly composed of a heat roller 81 incorporating a heat source, and a press roller 82 pressed against the heat roller 81. The sheet S on which the second transfer of a toner image is conducted goes into the nip between the heat roller 81 and the press roller 82, and is pressed and heated. Consequently, the toner image is fixed on the sheet S. After the fixing, the sheet S is delivered to the delivery tray 56 and the image forming (printing) is completed.

Next, the operation panel 4 is explained based on FIG. 2B. As shown in FIG. 2B, the operation panel 4 comprises a plurality of input/setting keys such as a ten-key pad 41, a start key 42 and the like, and further has a liquid crystal display portion 43. The liquid crystal display portion 43 is of the touch panel type. Users can conduct various settings (e.g., the settings of the number of printed sheets and a sheet size, enlargement/reduction processing, density changing, black-white reverse processing, frame erasure processing and the like) by pushing menu buttons displayed on the liquid crystal display portion 43. With the operation panel 4, the setting input of the size of the sheet S to be stored in the cassette 51 can also be done. Thus, the control portion 9 described later can determine the size of the sheet S stored in the cassette 51. The liquid display portion 43 can also display an operational situation of the apparatus and various messages. Although the detail is explained later regarding the present invention, the operation panel 4 receives a setting input of a threshold level to detect a boundary B between an effective image area T2 and a not-printed area T1, and displays an extraction situation of the effective image area T2 on the liquid crystal display portion 43 for confirmation (see FIG. 2C).

Although the detail is described later, FIG. 2C is briefly explained. FIG. 2 shows a display example on the liquid crystal display portion 43 when a user confirms an extraction situation of the effective image area T2. On the left side of the liquid crystal display portion 43, the effective image area T2 (the part shaded with slanting lines in FIG. 2C) which is extracted from the sheet S is displayed. Arranged on the right side of the liquid crystal display portion 43 are an OK button 43a which is pushed when the extraction of the effective image area T2 is suitably carried out, an extraction retry button 43b which is pushed when the extraction of the effective image area T2 is retried, a cancel button 43c to suspend the extraction of the effective image area T2, an enlargement button 43d which is pushed when the display on the left side of the liquid crystal display portion 43 is enlarged and displayed to confirm an extraction situation in detail, and a reduction button 43e to offer a reduced display.

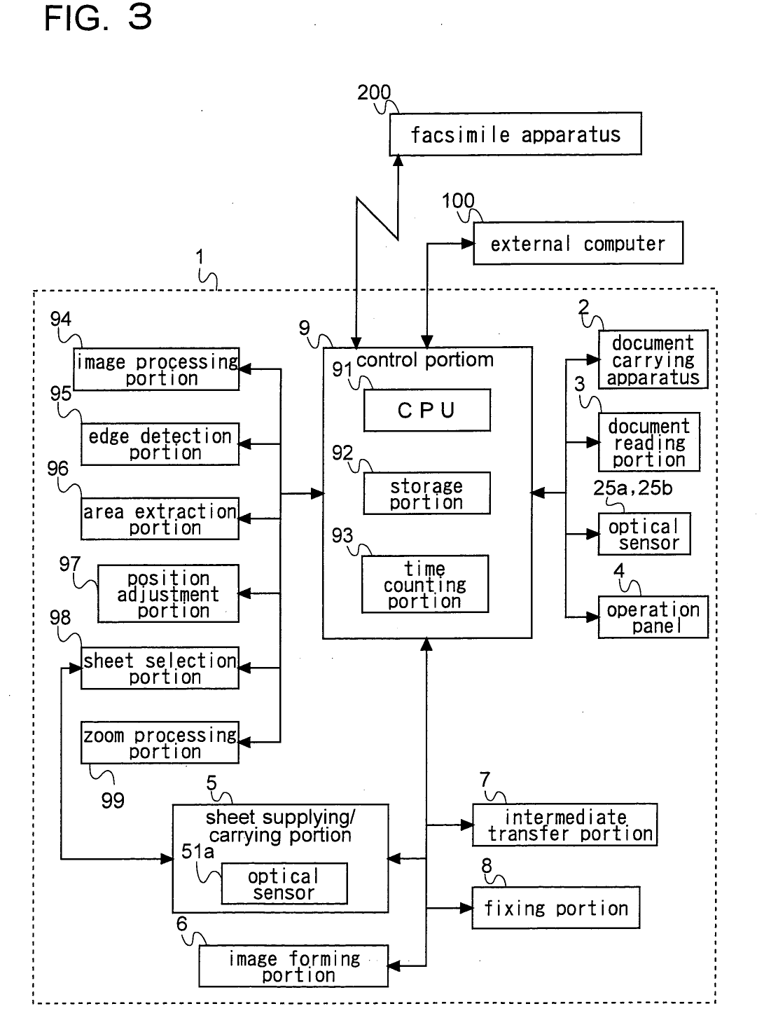

Next, a structure and processing of the multi-function printer 1 according to an embodiment of the present invention are explained based on FIG. 3. As shown in FIG. 3, the multi-function printer 1 according to the present embodiment has the control portion 9 mounted on a control board disposed in the multi-function printer 1. The control portion 9 controls the entire multi-function printer 1, and is constituted by, for example, a CPU 91, storage portion 92, time counting portion 93 and the like.

The CPU 91 is the central processing unit which executes operations, signal transmission based on control programs and control data stored in the storage portion and controls each portion of the multi-function printer 1. The storage portion 92 stores control programs and data, and is constituted by storage devices such as a ROM, a RAM, a HDD, a flash ROM and the like. The ROM, HDD, flash ROM store the control programs to control the multi-function printer 1, image data scanned by the document reading portion 3, setting information on the multi-function printer 1 and the like input by the user. The RAM is used to temporarily store the control programs, image data, and various data.

Each of the portions which constitute the multi-function printer 1 is connected to the control portion 9, and the control portion 9 controls, for example, the document reading portion 3, the image forming portion 6, the intermediate transfer portion 7 and the like. Thus, the multi-function printer 1 can form an image based on image data obtained by reading a document (copy function). Besides, in the structure described above, an external computer 100, a facsimile apparatus 200 and the like are connected to the control portion 9.

The external computer 100 is connected to the multi-function printer 1 via various networks and a cable and can perform transmission and reception of various data such as image data and the like. For example, a user's terminal (host computer) or another multi-function printer 1 is used as the external computer 100. The multi-function printer 1 can transmit image data obtained by reading a document with the document reading portion 3 to the external computer 100 (scanner function), and can also receive image data from the external computer 100 to form an image (printer function). A plurality of the external computers 100 may be connected.

The facsimile apparatus 200 is connected to the multi-function printer 1 via a public communication line and various networks, and can transmit and receive image data to and from the multi-function printer 1. An internet facsimile (network facsimile) is also used as the facsimile apparatus. Thus, the multi-function printer 1 can transmit image data which is obtained by reading a document with the document reading portion 3 or sent from the external computer 100 to the facsimile apparatus 200, and can also receive image data from the facsimile apparatus 200, print them, or store them in the storage portion 92 (facsimile function).

An image processing portion 94 is disposed as the portion which carries out various kinds of image processing on image data input on the multi-function printer 1 or stored in the storage portion 92. The image processing portion 94 may have a CPU dedicated to image processing, various memories, dedicated ICs and the like. The image processing portion 94 applies various kinds of image processing, for example, correction, density changing, half-tone processing and the like to image data read by the document reading portion 3. After the data processing, the image processing portion 94 transmits the data, for example, to the laser unit 64, where the laser unit 64 conducts scanning and exposure on each photosensitive drum 62 based on the image data transmitted.

The multi-function printer 1 is so structured for image processing as to have besides the image processing portion 94, an edge detection portion 95, an area extraction portion 96, a position adjustment portion 97, a sheet selection portion 98, and a zoom processing portion 99 and the like. These portions may be structured with software, or with hardware including various electronic parts, or disposed as portions which constitute a part of the control portion 9 and the image processing portion 94.

The edge detection portion 95 detects an edge (a part where density changes sharply) in image data. For example, as a method of detecting an edge, the differential filtering processing can be employed. The differential filtering processing forms a matrix in which pixel values are input in an area (e.g., 3×3, 9×9 etc.) centering a pixel in image data, and conducts differential filtering on the matrix. For example, as a differential filter, can be used a filter in which a pixel and the surrounding pixels of it are multiplied by a given coefficient (e.g., the central pixel is multiplied by an integer, and the surrounding pixels by −1). It can be determined whether or not the central pixel constitutes an edge based on if the sum total of all the pixel values in a matrix exceeds or not a given threshold.

The area extraction portion 96 is the portion which based on an edge detected by the edge detection portion 95 detects the boundary B between the not-printed area T1 and the effective image area T2 of image data in the fast scan and slow scan directions, and extracts the effective image area T2. To extract the effective image area T2, the area extract portion 96 may carries out processing to link the detected edges to each other so that the edges become continuous. Thus, the effective image area T2 in image data which is generated by reading a document with the document reading portion 3 or sent from the external computer 100 or the like to the multi-function printer 1 is extracted.

An effective image area T2 is a block of area in which a writing, graphics, symbols, pictures, or patterns etc. are printed, and which is not recognized as a not-printed area or a blank area. For example, as one effective image area for one sheet, the remaining part obtained by removing the marginal part extending from the circumferential edge toward the inside of a sheet may be defined as an effective image area T2. However, for example, when the printed areas are located apart from each other and can be extracted separately, a plurality of effective image areas T2 are extracted from one sheet S.

A boundary B can be defined, for example, by the number of lines in a not-printed part leading to a detected edge. In other words, if the number of dots (width) in a colored line (e.g., white) of the sheet S which continuously extending from an edge exceeds a given threshold (the number of dots), the area extraction portion 96 determines that the edge is a boundary B. The threshold may be set based on the reading resolution of the document reading portion 3 or the resolution of image data sent to the apparatus. Thresholds that are different from each other depending on the fast scan and slow scan directions may also be set. For example, in a case where if the same color continues 10 mm from a detected edge, the area extraction portion 96 recognizes the edge as a boundary B, assuming that the resolution of image data is 600 dpi and an inch is 25.4 mm, a threshold is calculated as follows:

10 (mm)÷25.4 (mm)×600 (dpi)≈236 (dots)

That is, the threshold is set to 236 dots.

As shown in FIG. 2B, threshold levels (e.g., 3- to 10-step levels) are displayed in a selectable fashion on the liquid crystal display portion 43 of the operation panel 4 so that a user can specify a threshold level to input a command to change a threshold (FIG. 2 shows that 7-step level selections are possible and the level 4 is in current selection in the fast scan direction). For example, the larger the threshold level number is, the less the number of lines in a colored part of a sheet S continuously extending from an edge can be to determine a boundary B. Besides, by using utility software installed in the external computer 100 (a user's terminal) to operate the multi-function printer 1, the same display as that on the liquid crystal display portion 43 may be performed so that a threshold level can be set on the external computer 100. In this case, the operation panel 4 serves as an operation input portion to set a threshold level. Upon a threshold level being input, it is transmitted to the control portion 9, and then, transmitted to the area extraction portion 96, and the threshold is changed by a constant width.

As shown in FIG. 2C, a user confirms the extraction situation in which the effective image area T2 is extracted on the extraction situation confirmation screen. In confirming, if the effective image area T2 is suitably carried out, the user pushes the OK button 43a. On the other hand, the extraction of the effective image area T2 is unsatisfactory, the user pushes the extraction retry button 43b. If the extraction retry button 43b is pushed, the user can set a threshold level again in the fast scan and slow scan directions as shown in FIG. 2B. Further, if the user desires to confirm the effective image area T2 in detail, the user pushes the enlargement button 43d. Then, the left-side display of the liquid crystal display portion 43 is enlarged at each push of the enlargement button 43d. In this case, a scroll bar may be displayed. On the other hand, if the user desires to confirm the entire effective image area T2, the user pushes the reduction button 43e.

The position adjustment portion 97 adjusts the position of the extracted effective image area T2 by moving it to the leading edge or trailing edge of the sheet S on which the image is formed. The position adjustment portion 97 can also collectively arrange and adjust the positions of a plurality of effective image areas T2 which are extracted from a plurality of document image data on one sheet S. A selection of the leading edge or the trailing edge of the sheet S to which the effective image area is moved can be input on the operation panel 4 or on the external computer 100. If the plurality of extracted effective image areas T2 cannot be accommodated on one sheet S, the position adjustment portion 97 can use more than one sheet S to rearrange them.

In the present embodiment, in forming the image of the effective image area T2 in full size, the sheet selection portion 98 selects the smallest possible sheet S from among the sheets S which have a size large enough to form the image thereon. Therefore, the sheet selection portion 98 checks to see which-size sheet S is stored in which cassette 51. Specifically, as shown in FIG. 3, the sheet supplying/carrying portion 5 is connected to the sheet selection portion 98 via a signal line, and the sheet selection portion 98 can make an inquiry about the sizes of the sheets S stored in the cassettes 51. Besides, because the sheet selection portion 98 is connected to the control portion 9, and the control portion 9 is connected to the sheet supplying/carrying portion 5, the sheet selection portion 98 can also obtain the information on the sizes of the sheets S stored in the cassettes 51 on the control portion 9.

For example, assuming that an effective image area T2 is extracted from image data on a 11 in.×17 in. (i.e., the tabloid size) document, and the image in the extracted effective image area T2 can be formed on a 5½ in.×8½ in. (i.e., the statement size) sheet S in full size. In this case, if sheets S of the statement size are stored in any one of the cassettes 51, in forming the image in the effective image area T2, the sheet selection portion 98 transmits a control signal to the sheet supplying/carrying portion 5 and the control portion 9 to make the sheet supplying/carrying portion 5 supply a sheet S of the statement size. On the other hand, in case where although sheets S of the statement size are not stored, sheets S of the 8½ % in.×14 in. size (i.e., the legal size) and sheets S of the 8½ in.×11 in. size (i.e., the letter size) are stored, to make the sheet supplying/carrying portion 5 supply a sheet S of the letter size, that is, the smaller size, the sheet selection portion 98 sends a control signal to the sheet supplying/carrying portion 5 and the control portion 9.

Further, assuming that an effective image area T2 is extracted from the image data on a document of another size, for example, A4-size, and the image in the extracted image area T2 can be formed on an A5-size sheet S in full size. In this case, if A5-size sheets S are stored in any one of the cassettes 51, in forming the image in the effective image area T2, the sheet selection portion 98 sends a control signal to the sheet supplying/carrying portion 5 and the control portion 9 to make the sheet supplying/carrying portion 5 supply an A5-size sheet S. On the other hand, in a case where although A5-size sheets S are not stored, A4-size sheets S and A3-size sheets S are stored, to make the sheet supplying/carrying portion 5 supply a sheet S of the A4-size, that is, the smaller size, the sheet selection portion 98 sends a control signal to the sheet supplying/carrying portion 5 and the control portion 9.

As described above (see FIGS. 1 and 3), in the multi-function printer 1 according to the present embodiment, the document carrying apparatus 2 and the document reading portion 3 have a plurality of optical sensors 25a and 25b that detect the size of a document to read. Each of the optical sensors 25a and 25b output a document size detection signal to the control portion 9, and the multi-function printer 1 according to the present embodiment uses the size information of the document to extract the effective image area T2.

In a specific method of detecting the size of a document, when the document carrying apparatus 2 carries a document, for example, the length in the document carrying direction is calculated by multiplying the time from the detection of the leading edge to the detection of the trailing edge by the document carrying speed (e.g., the time counting portion 93 of the control portion 9 measures the time). In addition, when a plurality of optical sensors 25a are arranged in the document tray along the document carrying direction, the length of a document in the document carrying direction can be obtained based on the position of an optical sensor 25a which has detected the presence of the document. On the other hand, the length of a document in the direction perpendicular to the document carrying direction can be calculated based on the position of an optical sensor 25a which is one of the optical sensors 25a arranged in the depth direction of the multi-function printer 1 and has detected the presence of the document. When a document is placed on the document contact glass plate 31b, the document size in the fast scan direction and the slow scan direction is obtained based on the position of an optical sensor 25b which is one of the optical sensors 25b arranged on the back side of the contact glass plate 31 and has detected the presence of the document.

In this way, the control portion 9 monitors the outputs from the optical sensors 25a and 25b, and the lengths in both directions, one parallel and the other perpendicular to the document carrying direction are detected, and thus it is determined as to the document has which one of the various sizes such as the tabloid-, letter-, legal-, statement-, A3-, A4-, A5-, A6-, B4-, and B5-size. The control portion 9 may detect the document size by confirming the resolution and the number of pixels in the fast scan and slow scan directions of the image data stored in the storage portion 92. In a case where the image data is transmitted from the external computer 100, the control portion 9 detects the size of the image data and the setting data attached to the image data, and thereby the size of the sheet S corresponding to the size of the image data can be recognized. In this case, the control portion 9 serves as a size detection portion of image data.

By detecting the image data size of the document and referring to the size information of the sheet S corresponding to the image data, for example, it can be determined that the size of the effective image area T2 is smaller than at least the detected size, and the extraction precision of the effective image area T2 can be enhanced. In addition, for example, it is possible to control the sheet selection portion 9 not to select a sheet S larger than the document size when the smallest sheet S is selected to print the effective image area T2.

The zoom processing portion 99 mentioned above is the portion which enlarges or reduces the digital size of image data, but in the present embodiment, a case where the content of image data is printed in full size is described, and the enlargement and reduction of image data are described in a second embodiment. Accordingly, the function of the zoom processing portion 99 is explained later.

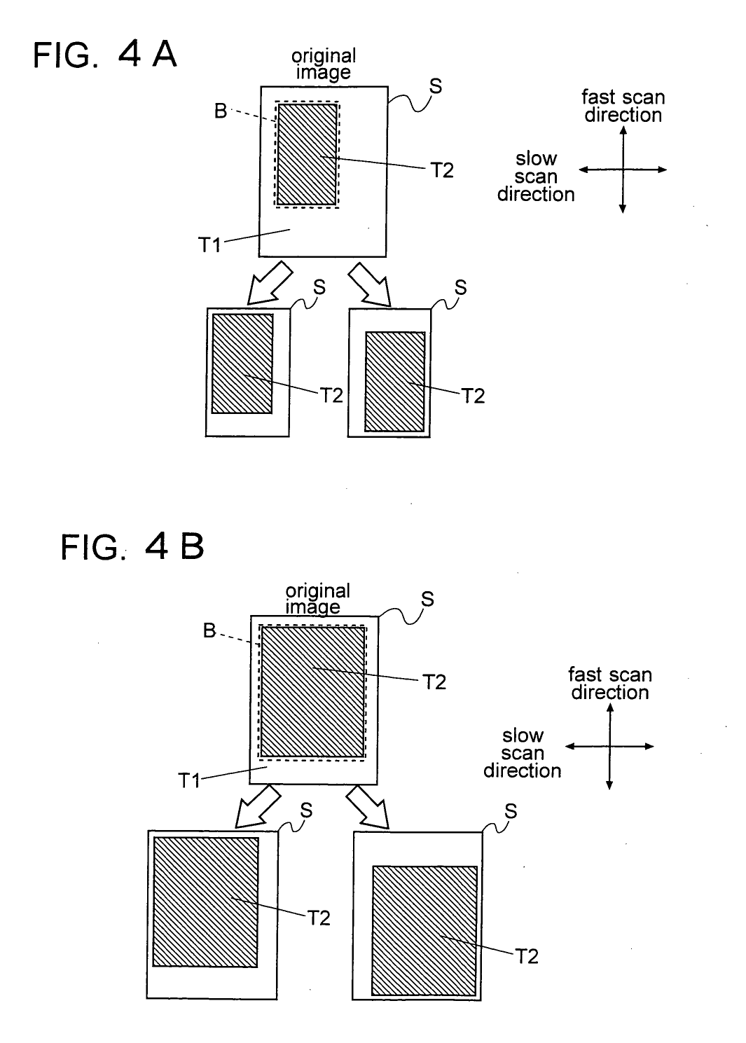

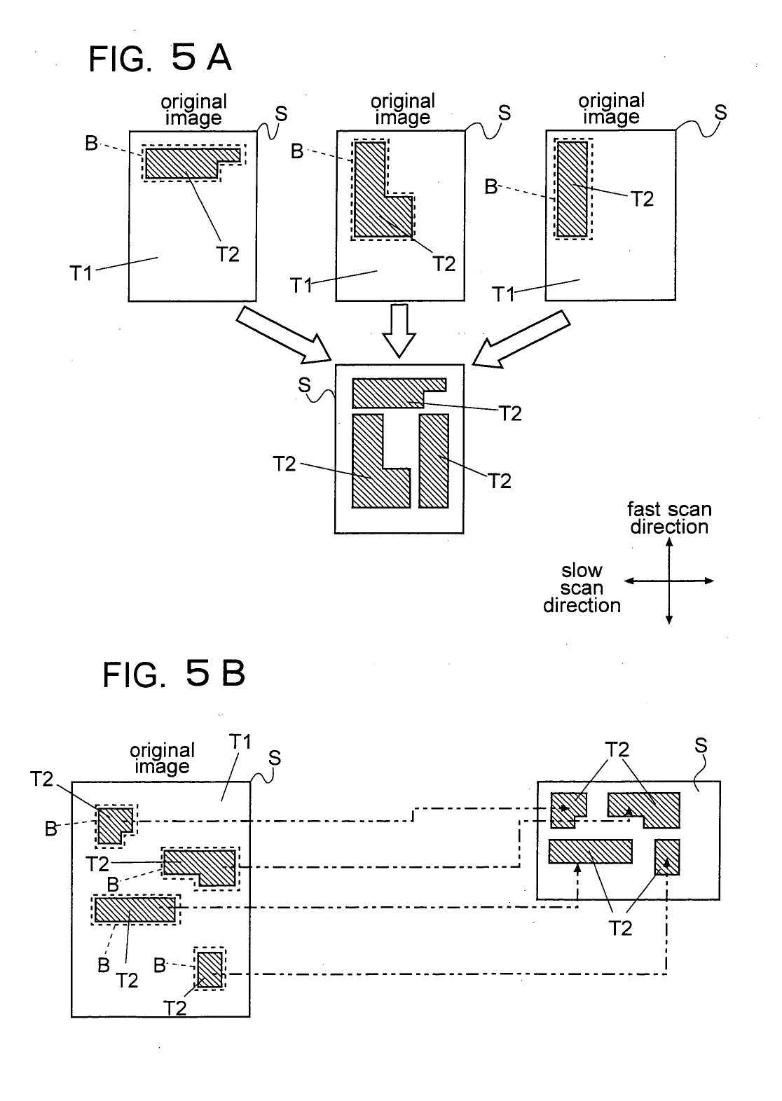

Next, specific extraction, position adjustment of the effective image area T2, and sheet selection in the present embodiment are explained based on FIGS. 4 and 5. In the present embodiment, a case where extracted image data is printed in full size is explained. In FIGS. 4 and 5, a slanting line shaded area is the effective image area T2, and a broken line indicates an example of the boundary B between the not-printed area T1 and the effective image area T2. The fast scan direction and the slow scan direction change depending on the direction of the sheet S stored in the cassette 51. In the present explanation, the longitudinal direction is defined as the fast scan direction and the transverse direction is defined as the slow scan direction in FIGS. 4 and 5.

As shown in FIG. 4A, there is a case where the original image data (hereinafter, called “the original image”) before extracting the effective image area T2 has only one part (the effective image area T2) of the sheet S where there are letters, pictures, patterns etc. The size of the image data that the multi-function printer 1 processes is determined depending on the printed part (part to transmit information) and the not-printed part. Therefore, if the not-printed part is large, the data size for the information size is large, and the data transmission and storage efficiencies are degraded. Besides, when only the printed part is clipped as a necessary part, the not-printed part is thrown away, which is undesirable in terms of effective use of resources.

Accordingly, in the present invention, only the printed part (the effective image area T2) is extracted from the original image. Specifically, the edge detection portion 95 detects the edge of the original image data, the area extraction portion 96 detects the boundary B in both the fast scan and slow scan directions, and then the image is formed adjusting the position of the effective image area T2 surrounded by the boundary B.

To begin with, FIG. 4A is explained. The area extraction portion 96 detects the boundary B shown by a broken line in the original image. Then, as shown by the outline arrows, the sheet selection portion 98 selects the smallest possible sheet S on which the effective image area T2 can be printed in full size based on the size of the effective image area T2, and it is printed. In FIG. 4A, as a result, the printing is made on the sheets S smaller than the original image sheet S. The position adjustment portion 97 adjusts the position of the effective image area T2 at the leading edge or the trailing edge of the selected sheet S. The position adjustment is made at the leading edge in the lower left and at the trailing edge in the lower right of FIG. 4A.

Thus, because the printing is carried out in full size, there are no missing parts of the letters, the patterns and the like (visibility maintained). Besides, even when the effective image area T2 is clipped, the not-printed part that is thrown away after the clipping can be made small. Moreover, because the effective image area T2 is moved to the leading edge or trailing edge of the sheet S, when clipping, one edge in the longitudinal direction and one in the transverse direction (two edges in all) only are clipped, thereby the clipping can be simplified.

Next, FIG. 4B is explained. FIG. 4B shows that the effective image area T2 in the original image is comparatively large. In this case, a sheet S smaller than the original image sheet S cannot be selected, but it is possible to adjust the position in the sheet S. The position adjustment is made at the leading edge of the sheet S in the lower left and at the trailing edge in the lower right of FIG. 4B. Thus, as in FIG. 4A, at least the clipping from the sheet S can be simplified.

Next, based on FIG. 5, explained is a case where a plurality of effective image areas T2 are extracted, and they are arranged in one sheet S. To begin with, FIG. 5A is explained. FIG. 5A shows that there are a plurality of original images, the effective image areas T2 are extracted from their respective original images and are collectively arranged in one sheet S. For example, imagined are various cases, in one of which the image data or text data on a plurality of image sheets received from a facsimile or an internet facsimile are collectively arranged on one sheet, or in another of which the materials clipped in the past are arranged on one sheet.

As shown in FIG. 5A, each of the original images on the plurality of image sheets has a large not-printed part (not-printed area T1) for the part to be printed (effective image area T2), and it is inefficient to print separately each of the original images, because the information size to be transmitted is small for the amount of the sheets to be used. Accordingly, in the present embodiment, each effective image area T2 is extracted from each of the plurality of original images, and they are collectively arranged on one sheet S, and then printed in full size. Such arrangement is possible, because the effective image area T2 is extracted by detecting the boundary B between the not-printed area T1 and the effective image area T2 in both the fast scan and slow scan directions. Because the effective image areas T2 are collectively arranged on one sheet S, the number of sheets S needed for the printing can be reduced from 3 to 1, and the power consumption and the time required for the image formation can also be reduced. Besides, because the information can be concentrated on one sheet S, it is not necessary to turn over pages, and it is also easy to confirm the printed content.

Next, a case where a plurality of effective image areas T2 are extracted from the image data on one image sheet is explained based on FIG. 5B. FIG. 5B shows that there is one original image sheet, and a plurality of effective image areas T2 are extracted from the original image sheet and then are collectively arranged on one sheet S. Imagined are various cases, in one of which for example, when materials to be edited are already attached to one sheet, the sheet is copied on a small sheet to make the material size small.

In such case, the multi-function printer 1 according to the present embodiment collectively arranges the effective image areas T2 on a sheet S smaller than the original image sheet and print them in full size. Accordingly, in clipping, the wasted part can be small, the power consumption and time required for the image formation can also be reduced, and thereby the resources can be effectively used. Even when clipping is not done, by concentrating the effective image areas T2 on one sheet, the information size of the sheet increases. In FIGS. 4 and 5, the case where the printing is performed is explained. However, FIGS. 4 and 5 can also be used in a case where the effective image areas T2 are extracted, the position adjustment portion 97 arranges them, and then the image data are stored. In other words, the size of the image data to be stored can be made small.

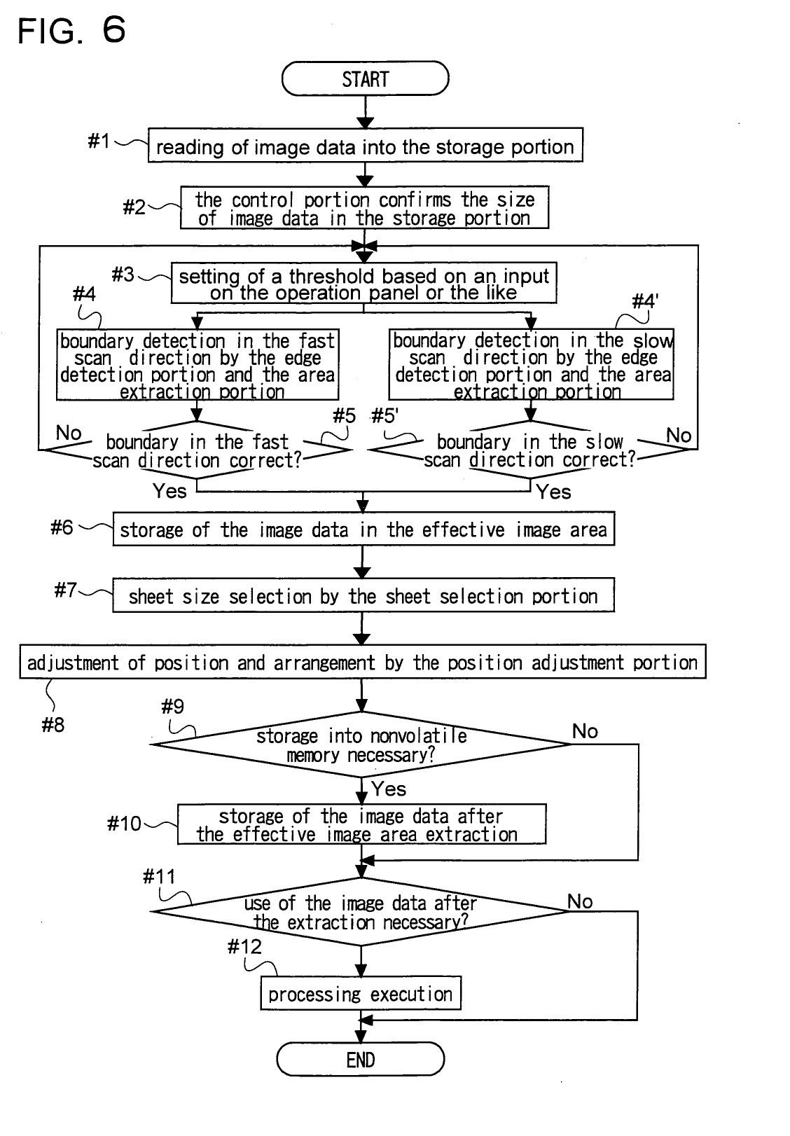

Next, the procedure in the present embodiment in which the effective image area T2 is processed is explained based on FIG. 6. In FIG. 6, the procedure starts immediately after the completion of the input of the processing mode on the operation panel 4 or on the user's terminal (the external computer 100) to extract the effective image area T2, adjust the position of the effective image area T2 and form the image. Because the multi-function printer 1 according to the present embodiment can execute usual processing, the procedure is carried out after the processing mode to perform the operations such as the extraction of the effective image area T2 and the like is selected and input on the operation panel 4.

To begin with, the image data on one or a plurality of sheets are read into a RAM or the like of the storage portion 92 (step #1). For duplication or facsimile transmission, the image data may be image data on a document read and digitized by the document reading portion 3, image data (e.g., image data for facsimile transmission/reception or for printing) transmitted from the external computer 100 or the facsimile apparatus 200 to the multi-function printer 1, or image data stored in the multi-function printer 1, in other words, there are no restrictions on the image data to be processed.

By confirming the outputs from the optical sensors 25a, 25b, the image data size, and the setting information, the control portion 9 finds the size of the sheet S corresponding to the image data (step #2). This is for an improvement of the extraction precision of the effective image area T2. Then, a threshold for the detection of the boundary B between the effective image area T2 and the not-printed part is input by the user on the operation panel 4 or the like and set (step #3). As described above, the threshold input may be done by selecting a level displayed, or by entering the threshold on the operation panel 4 or the like.

Based on the set threshold, the edge detection portion 95 and the area extraction portion 96 detect the boundary B in the fast scan and slow scan directions (longitudinal and transverse directions) of the sheet S (step #4, 4′). The user confirms the area extraction situation displayed on the liquid crystal display portion 43 of the operation panel 4 or on the display of the external computer 100 (see FIG. 2C), and checks if the detected boundary B is correct or not (step #5, 5′). This check can be done in both the fast scan and slow scan directions. If the boundary B is not detected correctly (No in step #5, 5′), the user can input another threshold again by pushing the extraction retry button 43b. On the other hand, if the boundary B is detected correctly (Yes in step #5, 5′), the OK button 43a is pushed.

When the boundary B is determined in both the fast scan and slow scan directions, the image data in the effective image area T2 surrounded by the boundary B is stored into a RAM or the like of the storage portion 92 (step #6). The size selection of the sheet S corresponding to the image data in the effective image area T2 is carried out by the sheet selection portion 98 (step #7). For example, when duplication or printing of image data received from a facsimile is carried out, selected is the smallest possible sheet S of the sheets S that can accommodate the image data in the effective image area T2 for the image formation even if the image formation is performed in full size and that are stored in the multi-function printer 1

Subsequently, the adjustment of the position and arrangement of the effective image area T2 is conducted by the position adjustment portion 97 for an actual printing (step #8). Here, the user selects the operation to or not to align the effective image area T2 with the leading edge or the trailing edge of the sheet S and the operation to or not to arrange a plurality of effective image areas T2 on one sheet S on the operation panel 4 or on the external computer 100.

Here, it is possible to check for the necessity of storing the image data after the adjustment by the position adjustment portion 97 into a nonvolatile memory of the storage portion 92 (step #9). If necessary (Yes in step #9), the image data obtained by arranging one or a plurality of effective image areas T2 on one sheet S is stored into a HDD or the like of the storage portion 92 of the multi-function printer 1 (step #10). In other words, the scan function of the multi-function printer 1 is used, and thereby the size of the image data to be stored can be reduced and the service efficiency of the storage apparatus can be improved. Then, it is checked for the necessity of using the image data after the extraction for actual printing or facsimile transmission (step #11). If necessary (Yes in step #11), printing or facsimile transmission etc. is executed (step #12).

In this way, accordion to the present invention, because the effective image area T2 is extracted by detecting the boundary B between the not-printed area T1 and the effective image area T2 in both the fast scan and slow scan directions, the not-printed part in the image data can be removed. And, because the smallest possible sheet S is so selected by the sheet selection portion 98 as to accommodate the extracted effective image area T2, and because the effective image area T2 is printed, for example, in full size, the visibility is not degraded and the smallest possible size of the sheet S used can be automatically selected. Besides, the waste produced at the time of clipping the formed image can be minimized, and the power consumption and the image data size to be processed can also be reduced.

Because the position of the effective image area T2 is adjusted by moving it to the leading edge or the trailing edge of the sheet S, the readability and the visibility of the formed image can also be enhanced. When clipping a necessary part, because the effective image area T2 is already moved close to an edge, the clipping is easily done. In addition, because the boundary B between the not-printed area T1 and the effective image area T2 is detected by finding the edges in both the fast scan and slow scan directions in the image data on a sheet, the boundary B can be exactly detected.

Because the effective image areas T2 derived from a plurality of image sheets are arranged on one sheet in full size, the visibility is not degraded, and the plurality of the effective image areas T2 can be concentrated on one sheet S, and the consumption of the sheets S can be curbed. The waste of the sheet S produced at the time of clipping the formed image, the power consumption, the image data size can be further reduced. Because the effective image area T2 is extracted from the image data obtained by the document reading portion 3, for example, a material or a magazine that the user has can be quickly edited. It is also possible to enhance the extraction precision of the boundary B between the not-printed part and the effective image area T2 by referring to the size of the sheet S in the image data or to the size of the read document.

The user can perform the threshold level setting for the extraction of the effective image area T2. That is, it is possible to enhance convenience for the user when conducting the area extraction. For example, even if the detection of the boundary B between the effective image area T2 and the not-printed area T1 is unsatisfactory, the boundary B is detected exactly if the user adjusts the threshold level. Moreover, because the image data in the extracted effective image area T2 obtained and extracted by removing the not-printed part is stored or saved, the image data having a small data size can be saved.

### Second Embodiment

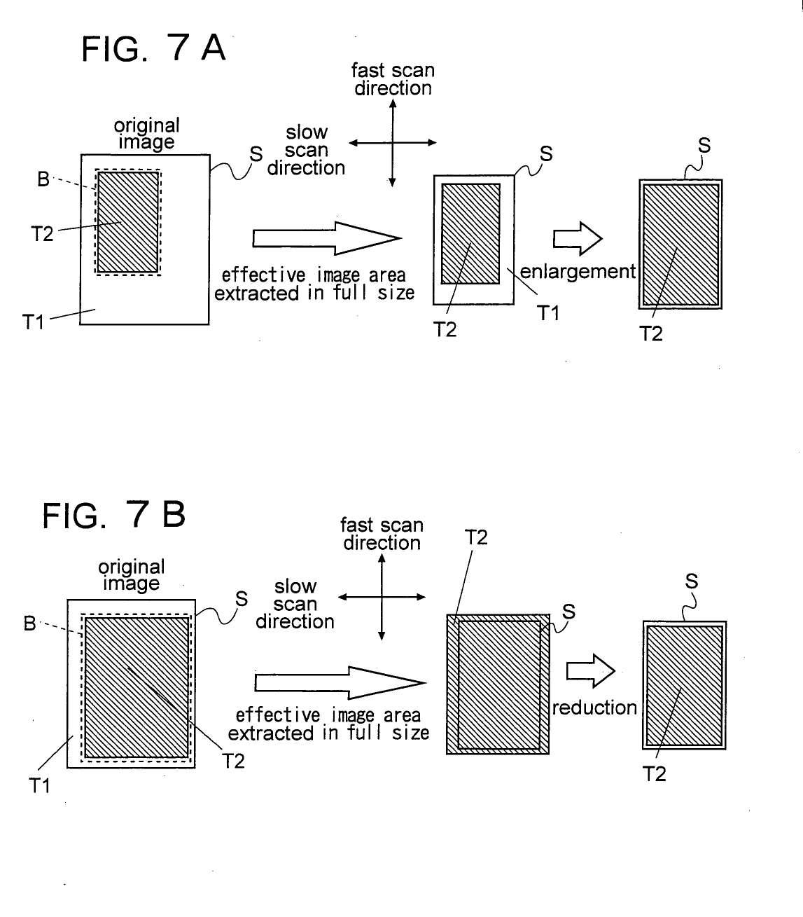

Next, a second embodiment of the present invention is described referring to FIGS. 7 to 9. In the first embodiment described above, the case where the printing is performed on a sheet in full size is explained. The present embodiment is different from the first embodiment in that the zoom processing portion 99 shown in FIG. 3 conducts the zoom processing on the image data. However, because the other processes are identical to those in the first embodiment, FIGS. 1 to 5 are quoted, and the characterizing part is explained with the same numerals attached to the same or similar parts.

First, FIG. 7A is explained. FIG. 7A shows that the effective image area T2 is extracted from the image data, and the zoom processing portion 99 enlarges the extracted effective image area T2 to fit it to the size of the sheet S. The sheet selection portion 98 may select the smallest sheet S from the sheets S stored in the cassettes 51. The sheet selection portion 98 may also select the smallest possible sheet S in which the effective image area T2 can be accommodated according to a magnification on the operation panel 4 input by the user. The user may select the size of the sheet S on the operation panel 4 or on the external computer 100 (in this case, an enlargement magnification can be easily obtained based on the ratio of the number of lines in the selected sheet S to the number of lines in the effective image area T2 in the fast scan and slow scan directions). Thus, the printable area of the selected sheet S is used to the full by enlarging the effective image area T2. In this way, the effective image area T2 is enlarged to enhance the visibility of the printed content.

Next, FIG. 7B is explained. FIG. 7B shows that the effective image area T2 is extracted from the image data, and the zoom processing portion 99 reduces the effective image area T2 to fit it to the size of the sheet S. Specifically, in a case where the effective image area T2 extracted from the original image is printed on the selected sheet S, the effective image area T2 can be too large. Accordingly, the zoom processing portion 99 reduces the effective image area T2 to accommodate it in the selected sheet S.

In this case, the sheet selection portion 98 may select the smallest possible sheet S of the sheets S that the multi-function printer 1 stores. The sheet selection portion 98 may also select the smallest sheet S in which the effective image area T2 can be accommodated according to a reduction power on the operation panel 4 input by the user. The user may also select the size of the sheet S to be used on the operation panel 4 or on the external computer 100 (in this case, the reduction magnification can be easily obtained based on the ratio of the number of lines in the selected sheet S to the number of lines in the effective image area T2 in the fast scan and slow scan directions). Thus, the selected sheet S can be used efficiently.

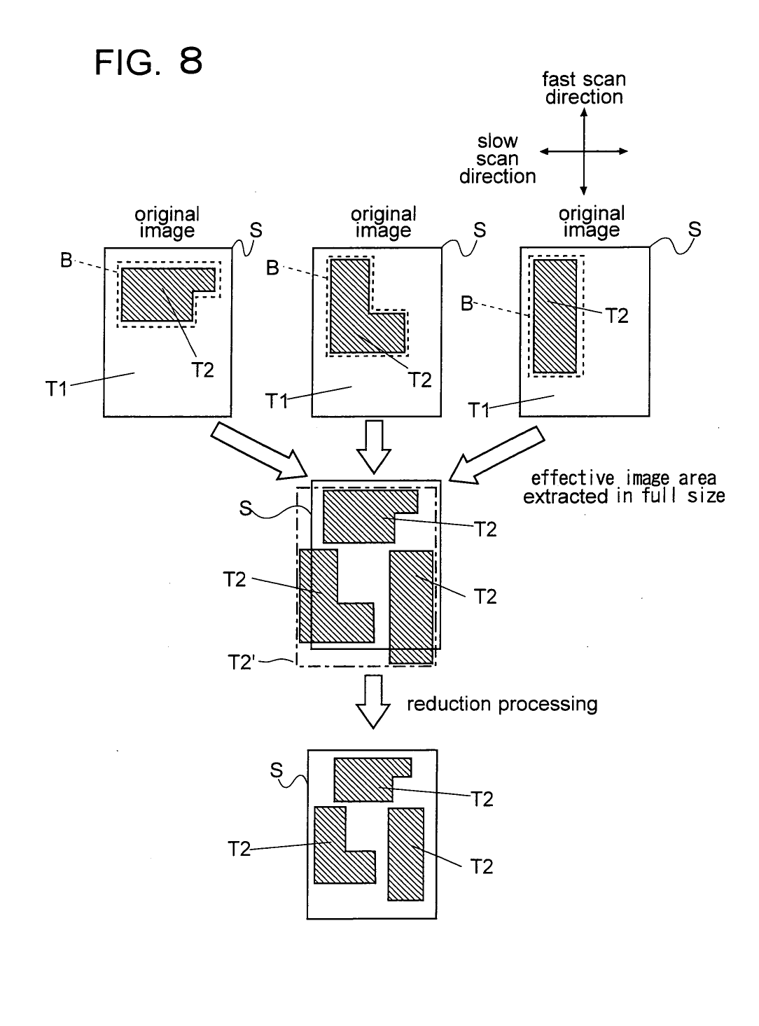

Next, FIG. 8 is explained. FIG. 8 shows that a plurality of effective image areas T2 are extracted from the image data derived from a plurality of sheets, and they are collectively arranged on one sheet for printing. As shown in the central part of FIG. 8, the selected sheet S can be too small to print the plurality of effective image areas T2 extracted from the plurality of image data in full size. Accordingly, in such a case, even if the printing is performed on the sheet selected by the user in full size, part of the effective image area T2 cannot be printed.

However, in the present embodiment, because the zoom processing portion 99 conducts the reduction processing on the image data in the effective image area T2, all the plurality of effective image areas T2 can be printed on the sheet S with no missing parts. The sheet selection portion 98 may select the smallest sheet S of the sheets S stored in the multi-function printer 1 as the sheet S used for the printing. The user also may select the sheet S to be used on the operation panel 4. Here, the reduction power can be easily obtained based on the ratio of the number of lines in the selected sheet S to the number of lines in the entire effective image area T2′ (shown by a one dot-one bar line in FIG. 8) obtained by collectively arranging the effective image areas T2 in the fast scan and slow scan directions. The sheet selection portion 98 may also select the smallest possible sheet S in which the effective image area T2′ can be accommodated according to a reduction magnification input on the operation panel 4 by the user. Thus, the sheet S selected by the user can be used efficiently.

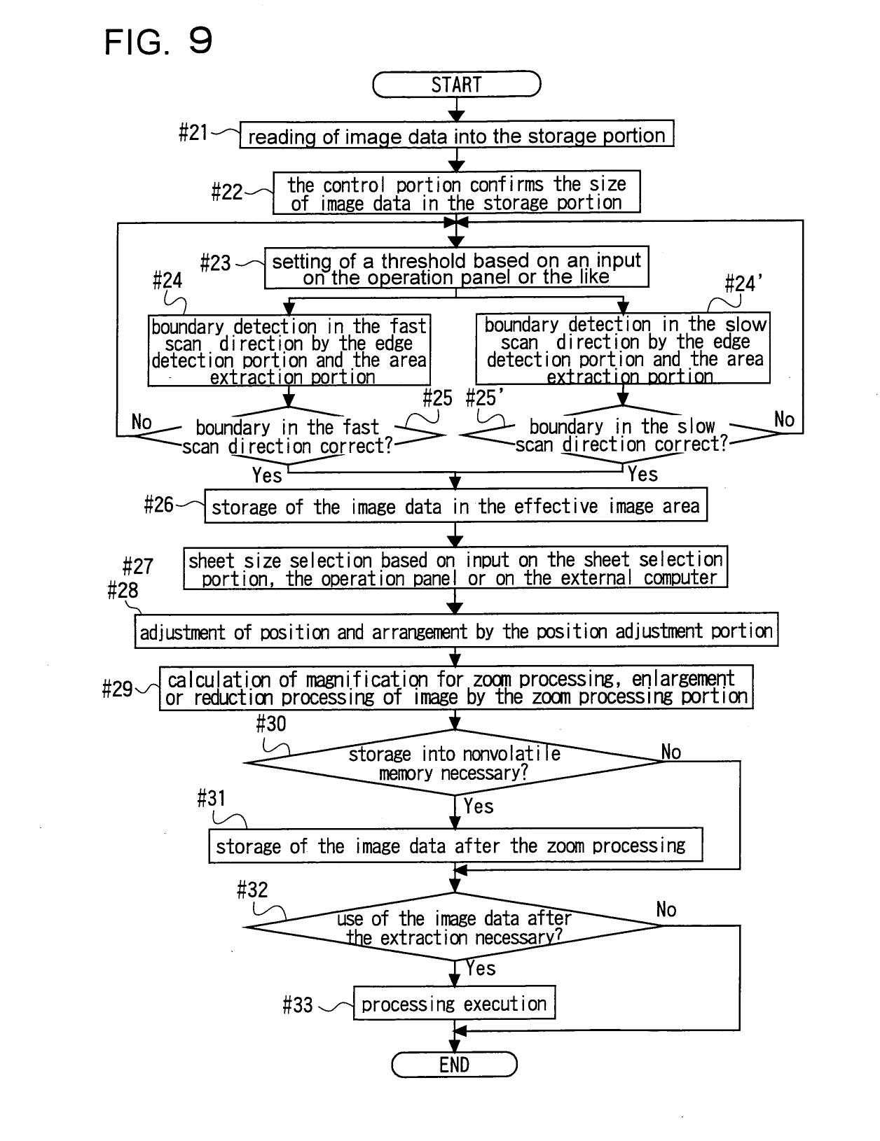

Next, the control procedure to conduct the enlargement and reduction is explained based on FIG. 9. Because the procedure is partly identical to that in the first embodiment explained using FIG. 6, the same parts are quoted with the explanations omitted. In FIG. 9, the procedure starts immediately after the completion of the input of the processing mode on the operation panel 4 or on the external computer 100 to extract the effective image area T2, adjust the position of the effective image area T2 and form the image making the enlargement and reduction. To start the procedure, the processing mode to perform the operations such as the extraction of the effective image area T2 and the like is selected on the operation panel 4.

Because the steps #21 to #26 are the same as the steps #1 to #6 in the first embodiment (see FIG. 6), the explanation is skipped. The size of the sheet S for one or a plurality of effective image areas T2 is selected on the sheet selection portion 98, the operation panel 4 or the external computer 100 (step 27). For example, the sheet selection portion 98 may select the smallest sheet S of the sheets S stored in the multi-function printer 1, or may select the smallest possible sheet S on which the effective image area T2 can be accommodated according to a magnification input on the operation panel 4. The user may specify any size such as the letter size etc.

Then, the adjustment of the position and arrangement of the effective image area T2 is executed by the position adjustment portion 97 for actual printing (step #28). To accommodate the entire effective image area T2 in the selected sheet S, the zoom processing portion 99 calculates the magnification for the zoom processing based on the number of pixels in the selected sheet S and the number of pixels in the entire effective image area T2, and applies the enlargement or reduction processing to the effective image area T2 (step #29). If the magnification for the zoom processing is already input on the operation panel 4, the calculation is unnecessary. The steps #30 to #33 are identical to the steps #9 to #12, and the explanation is skipped. When storing image data into the storage portion 92 in the step #31, the image data after the completion of the zoom processing in the step #29 can be stored.

Thus, in the second embodiment, because the zoom processing portion 99 applies the enlargement or reduction processing to the image data in the effective image area T2, even if one or a plurality of effective image areas T2 cannot be accommodated in one sheet S in full size, it can be reduced to accommodate in one sheet S. Besides, even if a large not-printed area T1 remains in the sheet S with one or a plurality of effective image areas T2 arranged in the sheet S, the effective image area T2 can be enlarged to use the sheet S efficiently, and the image data in the effective image area T2 can be read easily.

Heretofore, the embodiments of the present inventions are described. However, the scope of the present invention is not limited to these embodiments, and various modifications can be made within the scope of the present invention.

What is claimed is:

1. An image forming apparatus comprising:
an area extraction portion for detecting a boundary between a not-printed area and an effective image area which is not a not-printed part in image data in both the fast scan and slow scan directions and for extracting one or a plurality of the effective image areas;
a sheet selection portion for in forming an image selecting the smallest possible sheet of the sheets which have a size to accommodate the image to be formed and are used by the apparatus; and
an image forming portion for forming the image on the sheet which the sheet selection portion selects based on the image data in the effective image area extracted by the area extraction portion.

2. The image forming apparatus according to claim 1, further comprising:
a position adjustment portion for adjusting the position of at least one of the extracted effective image areas by moving the effective image area to the leading edge or the trailing edge of a sheet,
wherein, the position adjustment portion is capable of adjusting the position of the plurality of effective image areas extracted from the image data in one or a plurality of image sheets by arranging the effective image areas in one sheet.

3. The image forming apparatus according to claim 1, wherein the area extraction portion detects the boundary between the effective image area and the not-printed part based on an edge in the image data detected in both the fast scan and slow scan directions.

4. The image forming apparatus according to claim 2, wherein the area extraction portion detects the boundary between the effective image area and the not-printed part based on an edge in the image data detected in both the fast scan and slow scan directions.

5. The image forming apparatus according to claim 1, further comprising:
a document reading portion for reading a document and generating image data,
wherein the area extraction portion extracts the effective image area in the image data read and generated by the document reading portion.

6. The image forming apparatus according to claim 2, further comprising:
a document reading portion for reading a document and generating image data,
wherein the area extraction portion extracts the effective image area in the image data read and generated by the document reading portion.

7. The image forming apparatus according to claim 1, further comprising:
a image data size detection portion for detecting a sheet size for the image data for the image formation.

8. The image forming apparatus according to claim 2, further comprising:
a image data size detection portion for detecting a sheet size for the image data for the image formation.

9. The image forming apparatus according to claim 5, further comprising:
a document size detection portion for detecting a document size to be read.

10. The image forming apparatus according to claim 6, further comprising:
a document size detection portion for detecting a document size to be read.

11. The image forming apparatus according to claim 1, further comprising:
an operation input portion for operating and commanding the apparatus,
wherein, the operation input portion receives a threshold level setting for detecting the boundary between the not-printed part and the effective image area.

12. The image forming apparatus according to claim 2, further comprising:
an operation input portion for operating and commanding the apparatus,
wherein, the operation input portion receives a threshold level setting for detecting the boundary between the not-printed part and the effective image area.

13. The image forming apparatus according to claim 1, further comprising:
a storage portion for storing the extracted effective image area as image data.

14. The image forming apparatus according to claim 2, further comprising:
a storage portion for storing the extracted effective image area as image data.

15. The image forming apparatus according to claim 1, comprising:
a zoom processing portion for enlarging or reducing image data,
wherein, the zoom processing portion enlarges or reduces the effective image area.

16. The image forming apparatus according to claim 2, comprising:
a zoom processing portion for enlarging or reducing image data,
wherein, the zoom processing portion enlarges or reduces the effective image area.
